(19) United States
(12) Patent Application Publication
(10) Pub. No.: US 2010/0110888 A1
(43) Pub. Date: May 6, 2010

(54) METHOD OF PREVENTING DATA COLLOSIONS IN BEACON-ENABLED ZIGBEE SYSTEM HAVING TREE ROUTING SCHEME

(75) Inventors: Jongjun Park, Kyungsanobuk-do (KR); Jong-Oh Lee, Daejeon-city (KR); Hoon Jeong, Daejeon-city (KR); Sun-Joong Kim, Daejeon-city (KR); Cheol-Sig Pyo, Daejeon-city (KR); Jong-Suk Chae, Daejeon-city (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ELECTRONICS AND TELECOMMUNICATIONS RESEARCH INSTIT, Daejeon-city (KR)

(21) Appl. No.: 12/532,826

(22) PCT Filed: Oct. 24, 2007
(86) PCT No.: PCT/KR2007/005267

§ 371 Date: Sep. 23, 2009

(30) Foreign Application Priority Data
Mar. 23, 2007 (KR) 10-2007-0028885

(51) Int. Cl. H04L 1/00

(52) U.S. Cl. 370/230

(57) ABSTRACT

Provided is a method of preventing a data collision that occurs when two or more child nodes simultaneously transmit data to a parent node in a ZigBee network having a tree routing scheme and operating in a beacon mode. In the ZigBee system having the tree routing scheme and operating in the beacon mode, data communication to the parent node is performed in a beacon frame of the parent node. Here, when several child nodes exist under a single parent node, the child nodes transmit data to the parent node at the moment of receiving the beacon of the parent node, so that the data collision may occur when the child nodes simultaneously transmit the data to the parent node in the beacon frame of the parent node. In the method of preventing a data collision, each of the two or more child nodes is set to wait for its guard time (delay time) when transmitting data to the parent node to induce a normal slotted carrier sense multiple access with collision avoidance (CSMA-CA) operation. Therefore, the data collision can be prevented.

### TECHNICAL FIELD

This application claims the benefit of Korean Patent Application No. 10-2007-0028885, filed on Mar. 23, 2007, in the Korean Intellectual Property Office, the disclosure of which is incorporated herein in its entirety by reference.

The present invention relates to a ZigBee network, and more particularly, to a method of preventing data collisions that occur when two or more child nodes simultaneously transmit data to a parent node in a beacon mode based on a tree routing scheme.

This work was supported by the IT R&D program of MIC/IITA (Ministry of Information and Communication/Institute for Information Technology Advancement). [2005-S-038-02, Development of UHF RF-ID and Ubiquitous Networking Technology]

### BACKGROUND ART

ZigBee is a low-power wireless standard in a wireless communication technology, requiring a lower transmission data rate as compared with Bluetooth, low power to enable a battery to run for a year, and about half a cost of Bluetooth by minimizing software and associated components. Therefore, the ZigBee is appropriate for a home network that can be used for control and sensing. The ZigBee has an advantage in that tens of thousands of devices can be connected in networks unlike Bluetooth connecting hundreds of devices in networks.

The ZigBee network operates in two main modes: beacon mode and non-beacon mode. In the beacon mode, full function device (FFD) nodes defined in the ZigBee network periodically transmit beacons, so that the nodes in the network perform data transmission/reception only in a predetermined beacon frame period.

In the beacon mode, the nodes in the ZigBee network periodically ‘wake up’ and sleep to reduce power consumption. Particularly, in a tree routing scheme, a node wakes up in a beacon frame of a parent node and performs data transmission/reception with the parent node, and wakes up in its beacon frame and performs data transmission/reception with its child nodes. The nodes sleep between other beacon frames to reduce power consumption.

In the ZigBee network, data transmission/reception is performed in a carrier sense multiple access with collision avoidance (CSMA-CA) method. In the CSMA method, data of a queue is transmitted when a current frequency channel is clear, that is, when there is no carrier in the channel, so as to avoid data collisions.

In a slotted CSMA-CA method, a beacon period and a backoff slot are synchronized. In addition, after checking whether or not the channel is clear in a slot in which data transmission can be performed, data is transmitted after the backoff slot. When the channel is not clear and has been used, the data transmission is deferred for a backoff slot time corresponding to a random number, and checking whether or not the channel is clear is performed again. When the data transmission completion time is not in the beacon frame period, data is not transmitted but stacked in a queue, and the node returns to sleep.

When the nodes in the ZigBee network operate in the beacon mode, the slotted CSMA-CA method is used to perform data transmission. A child node wakes up at a beacon time of a parent node and receives a beacon of the parent node for synchronization, and transmits data to the parent node in a slot of the parent frame by using the slotted CSMA-CA. Here, after receiving data, the parent node replies with an acknowledgement (ACK) signal. When the child node does not receive the ACK for a predetermined period after transmitting data, the child node re-transmits the data. In order for the parent node to transmit data to the child node, the parent node informs the child node that there is data to be transmitted by using a beacon as a pending message. Here, after receiving the beacon of the parent node, the child node replies with a data request message by using the slotted CSMA-CA. After receiving the data request message from the child node, the parent node transmits the data to the child node immediately or by using the slotted CSMA-CA. Here, the beacon and the ACK are transmitted without using the CSMA-CA.

In the beacon mode, when the child node transmits data to the parent node, the beacon of the parent node is synchronized with the backoff slot, so that all child nodes that belong to the parent node execute the slotted CSMA-CA at the same time. Therefore, data collisions between parent-child nodes occur.

FIG. 1 is a view illustrating an example of the data collision that occurs in the ZigBee network having the tree routing scheme and operating in the beacon mode.

Referring to FIG. 1, p represents a personal area network (PAN) coordinator having an FFD type of the ZigBee network, r1, r2, and r3 represent routing nodes having the FFD type, each of which operating as a coordinator, and e represents a node having a reduced function device (RFD) type and operating as an end device.

In the ZigBee network having the tree routing scheme, the coordinator having the FFD type can communicate with its parent node (or parent) and its child nodes (or children). On the other hand, the device having the RFD type can communicate only with its parent node. In order for the device having the RFD type to communicate another node, data is relayed through the parent node over hops.

When the ZigBee network having the tree routing scheme operates in the beacon mode, a node can communicate with its parent only in a beacon frame of the parent and communicate with its child only in its beacon frame. In the beacon mode, the node sleeps between beacon frames so as to turn off RX to save power. In FIG. 1, when data to be transmitted from the r1, r2, and e1 nodes to the p occurs, the data is transmitted in the beacon frame of the p.

FIG. 2 is a view illustrating a beacon frame in the ZigBee network configured as illustrated in FIG. 1.

Referring to FIG. 2, in the ZigBee network operating in the beacon mode, a superframe period is split to be used with time division multiple access (TDMA). Each period is a unique beacon frame period of each of the coordinators included in the network as illustrated in FIG. 2 and the periods are set so as not to overlap. The number of split periods is determined by a superframe order (SO) and a beacon order (BO) that are initially set by a ZigBee standard. A beacon frame of each coordinator starts with beacon transmission.

FIG. 3 is a view illustrating operations of two child nodes that transmit data with different lengths to a parent node in a beacon frame of the parent node.

Referring to FIG. 3, when the child nodes have data that is to be transmitted to the parent node, the child nodes wait until receiving a beacon of the parent node and transmit the data after receiving the beacon of the parent node. Each child node wakes up right before the beacon of the parent node is transmitted and receives the beacon of the parent node. In the beacon mode, each child node performs synchronization on the basis of the beacon of the parent node. Therefore, when several child nodes that belong to the same parent node transmit data to the parent node, the child nodes determine that a channel is clear using the CSMA-CA method and simultaneously transmit the data.

When two nodes transmit data with different lengths to the parent node, a data collision occurs once, and the two nodes re-transmit the data to the parent node in the CSMA-CA method. In this case, the data collision always occurs at the first data transmission, so that a data arrival time is delayed, and the data re-transmission has to be performed, so that power consumption increases. In addition, when the data of the first child node is longer than that of another node, all of the data cannot be transmitted in the beacon frame of the parent node, and the data transmission is deferred until a next parent beacon frame so that the data is transmitted at the next frame. In this case, the data arrival time is delayed, and this results in degradation of a performance of the network.

FIG. 4 is a view illustrating operations of two child nodes that transmit data with the same length to the parent node in the beacon frame of the parent node.

Referring to FIG. 4, when the lengths of data to be transmitted from the two nodes are the same, the data cannot be transmitted to the parent node permanently. Moreover, since the two nodes occupy the entire beacon frame period of the parent node, other child nodes cannot transmit the data. If this only occurs once, there is a problem in that communication between the parent and corresponding child nodes in the network cannot be performed permanently.

In the above example, transmission of two nodes is described. However, in the ZigBee network having the tree routing scheme, several child nodes exist under a single parent node. Therefore, when two or more child nodes from among the several child nodes transmit data with the same length to the parent node, any communication between the parent and the child nodes cannot be performed. On the other hand, although data with different lengths is transmitted, when a large number of child nodes exist, data delay and power consumption significantly increase. The data collisions occur when the child nodes that perform synchronization with the beacon frame of the parent node cannot execute the CSMA-CA properly.

### DISCLOSURE OF INVENTION

### Technical Problem

In the ZigBee network having the tree routing scheme, several child nodes exist under a single parent node. Therefore, when two or more child nodes from among the several child nodes transmit data with the same length to the parent node, any communication between the parent and the child nodes cannot be performed. On the other hand, although data with different lengths is transmitted, when a large number of child nodes exist, data delay and power consumption significantly increase. The data collisions occur when the child nodes that perform synchronization with the beacon frame of the parent node cannot execute the CSMA-CA properly.

### Technical Solution

The present invention provides a method of preventing data collisions in a ZigBee system having a tree routing scheme in a beacon mode, capable of allowing each of two or more child nodes that belong to a parent node to wait for a time delay set for each child node and transmit data to the parent node at a different time so as to induce a normal slotted carrier sense multiple access with collision avoidance (CSMA-CA) operation.

### ADVANTAGEOUS EFFECTS

In the present invention, by generating the guard time, the data collision that occurs when two or more child nodes simultaneously transmit data to the parent node in the ZigBee system having the tree routing scheme and operating in the beacon mode can be prevented. Therefore, data transmission period delay due to the data collision, power consumption due to re-transmission, and a phenomenon in which transmission data occupies a channel according to its length during a beacon frame period and data transmission/reception is blocked can be prevented.

Accordingly, in the ZigBee system having the tree routing scheme in which two or more child nodes belong to a single parent node and operating in the beacon mode, each node sets a different time delay right before transmitting data to the parent node to have a different data transmission start point, so that a data collision that occurs when the child nodes simultaneously transmit data to the parent node can be prevented.

Therefore, data transmission period delay due to the data collision and power consumption due to re-transmission can be reduced.

### DESCRIPTION OF DRAWINGS

The above and other features and advantages of the present invention will become more apparent by describing in detail exemplary embodiments thereof with reference to the attached drawings in which:

FIG. 1 is a view illustrating an example of a case where child nodes transmit data to a parent node in a ZigBee network having a tree routing scheme and operating in a beacon mode;

FIG. 2 is a view illustrating a beacon frame of each node in the ZigBee network configured as illustrated in FIG. 1;

FIG. 3 is a view illustrating a data collision that occurs when two child nodes transmit data with different lengths to a parent node in a beacon frame period of the parent node;

FIG. 4 is a view illustrating a data collision that occurs when two child nodes transmit data with the same length to a parent node in a beacon frame period of the parent node;

FIG. 5 is a view illustrating normal operations of nodes when a guard time is generated by using a random delay according to an embodiment of the present invention;

FIG. 6 is a view illustrating ZigBee parameters for generating a static guard time according to another embodiment of the present invention; and

FIG. 7 is a flowchart of a method of preventing data collisions according to an embodiment of the present invention.

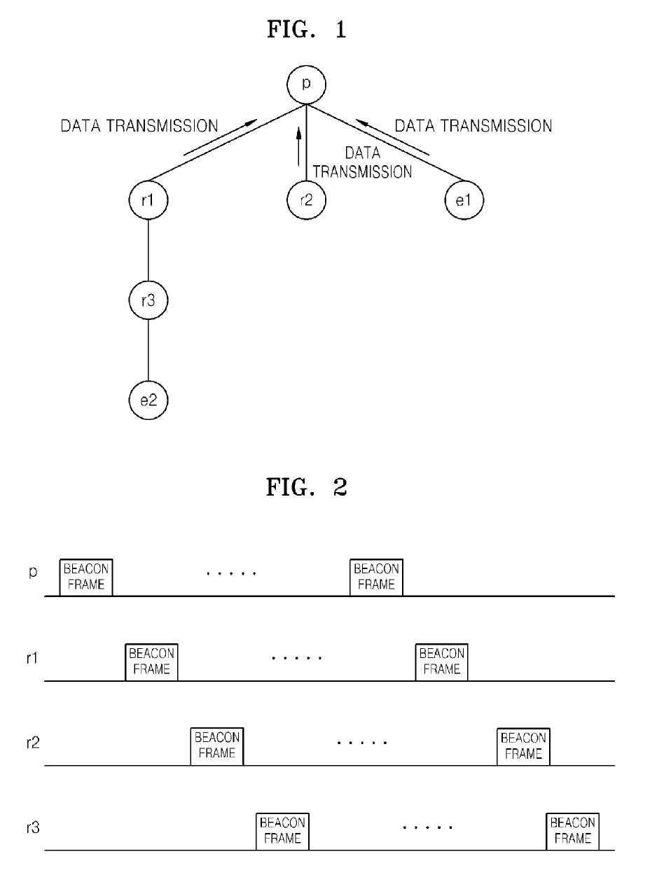

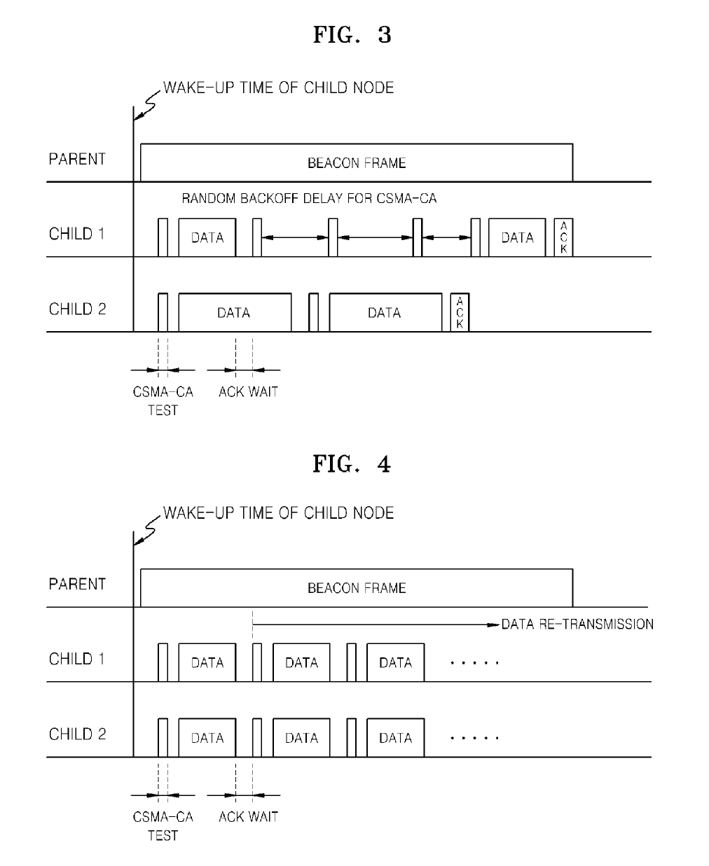

### BEST MODE

According to an aspect of the present invention, there is provided a method of preventing a data collision that occurs when two or more child nodes that belong to a single parent node transmit data to the parent node in a ZigBee network operating in a beacon mode, the method including: performing an operation of the same function to set a different time delay by each of the two or more child nodes synchronized with a beacon received from the parent node; and detecting whether or not a carrier signal exists in a channel after the set time delay and determining whether or not to transmit data to the parent node.

In the above aspect of the present invention, the time delay may be set based on a random number.

In addition, the time delay may be set by a function operation of [basis time×mod(a, b)] or a function operation of [basis time×{(addresses of child nodes−address of parent node)/Cₛₖᵢₚ(d)}], where mod(a, b) is a function of returning a remainder after dividing a by b, a is a return function of the random number, b is the number of slots, and Cₛₖᵢₚ(d) is a block portion size of an address that a node having a depth d has.

According to another aspect of the present invention, there is provided a computer-readable medium having embodied thereon a computer program for the method of preventing data collisions in the ZigBee network.

Accordingly, the data collision problem that occurs when two or more child nodes that belong to a single parent node simultaneously transmit data to the parent node in the ZigBee network having a tree routing scheme and operating in a beacon mode can be solved.

### MODE FOR INVENTION

Hereinafter, exemplary embodiments of the present invention will be described in detail with reference to the attached drawings. Like reference numerals designate like elements throughout the specification. In the description, the detailed descriptions of well-known functions and structures may be omitted so as not to hinder the understanding of the present invention.

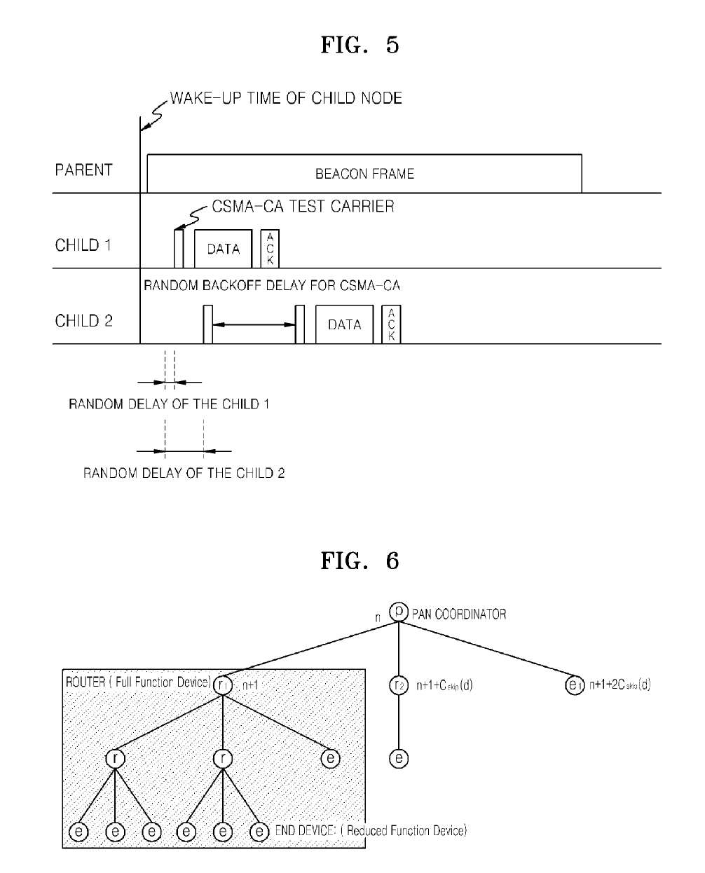

According to an embodiment of the present invention, a time delay for carrier sense multiple access with collision avoidance (CSMA-CA) is generated right before data transmission. Specifically, each child node generates a guard time so that several child nodes that belong to a parent node have slightly different data transmission start points from each other. Therefore, whether or not a channel is used can be normally determined in the CSMA-CA method, and data transmission to the parent node can be performed without data delay. As a method of generating the guard time, two methods are described with reference to FIGS. 5 and 6.

FIG. 5 is a view illustrating operations of nodes in a network when a guard time is generated by using a random delay according to an embodiment of the present invention.

Referring to FIG. 5, each child node waits for a guard time as represented in Equation 1 before transmitting data to a parent node and then transmit the data by using CSMA-CA.

guard_time_unit×mod(rand( ), # of slot) [Equation 1]

According to the embodiment, a method of setting different guard times for child nodes by using a random number is used. Here, ‘guard_time_unit’ represents a basis time unit. The ‘guard_time_unit’ is set to a value larger than a backoff slot length for the CSMA-CA.

In Equation 1, mod(a,b) represents a function for returning a remainder after dividing a parameter a by a parameter b. In addition, rand( ) corresponding to the parameter a represents a function of returning a random number. In addition, ‘# of slot’ corresponding to the parameter b represents the number of slots and is set to a value equal to or larger than a nwkMaxChildren(Cm) value that is one of ZigBee network parameters and represents the maximum number of child nodes of a routing node, and the value may be set so as not to increase the data delay excessively. As the value b increases, collision possibility decreases, and the data delay due to the guard time increases.

Child nodes 1 and 2 wake up by receiving a beacon of a parent node and are synchronized with the received beacon of the parent node. Next, each of the child nodes 1 and 2 sets a guard time that is a time delay to wait right before data transmission by using Equation 1. When the child node 1 determines after the set guard time that a channel is clear, the child node 1 transmits the data to the parent node. The child node 2 checks a channel after its set guard time, determines that the channel is not clear during the data transmission of the child node 1, waits for a random backoff slot time, and then transmits the data.

According to the current embodiment, transmission of two nodes is described. However, the transmission method can be applied to two or more child nodes.

In the aforementioned method, a similar importance is set for each child node. However, data collision may occur with a low possibility. The data collision occurs when the smallest value of the result of ‘mod(rand( ), # of slot)’ duplicates from among several child nodes. Therefore, if the smallest value does not duplicate, the data collision does not occur. In addition, the data collision possibility is very low, and although a collision occurs, a guard time is generated again by using a random number during the next transmission, so that a data collision chain as illustrated in FIG. 4 does not occur.

FIG. 6 is a view illustrating ZigBee parameters for generating a static guard time according to another embodiment of the present invention.

According to the current embodiment, a guard time is generated by using the parameters of the ZigBee network as represented in Equation 2 without the random delay.

guard_time_unit×(nwkAddr−parent_nwkAddr)/Cₛₖᵢₚ(depth) [Equation 2]

Each parameter of Equation 2 is a value defined in the ZigBee standard. Here, nwkAddr represents an address value of a child node, parent_nwkAddr represents an address value of a parent node, and Cₛₖᵢₚ represents a block portion size of an address that a node having a depth of d can have.

Referring to FIG. 6, when a network address is allocated according to the ZigBee standard, for example, a personal area network (PAN) coordinator p and child nodes r1, r2, and e1 having a parent node p have addresses n, n+1, n+1+Cₛₖᵢₚ, and n+1+2Cₛₖᵢₚ, respectively.

According to Equation 2, the address of the parent node subtracted from the addresses of the child nodes are 1, C_{Skip}+1, and 2C_{Skip}+1, respectively. Next, if the remaining values are divided by C_{Skip}(d), the child nodes have values of 0, 1, and 2, respectively. Therefore, as a child node from among the child nodes having the same parent node has a smaller address value, the child node has a shorter guard time.

As described above, when the guard time is generated, any data collision between the child nodes and the parent node can be avoided. In this case, data of a child node having a smaller address value nwkAddr is firstly transmitted, so that there is a problem in terms of quality of service (QoS). However, The ZigBee network having the tree routing scheme and operating in the beacon mode rarely considers the QoS, so that the method according to the current embodiment may be applied to an application that does not need to consider the QoS, instead of the method using the random delay according to the embodiment illustrated in FIG. 5.

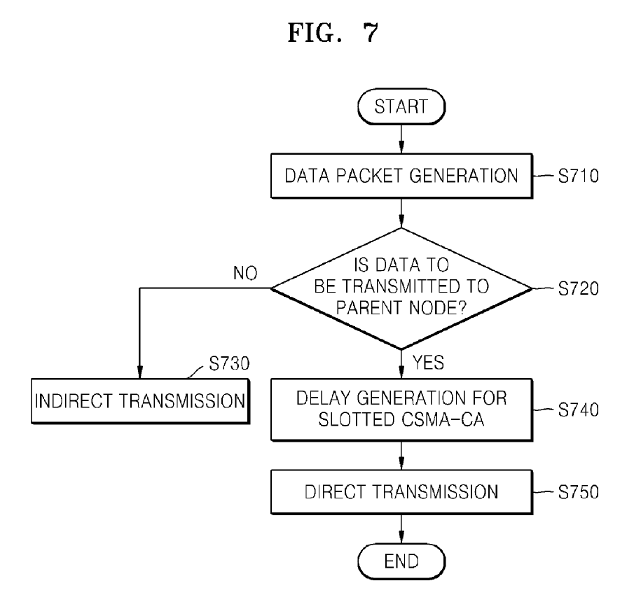

FIG. 7 is a flowchart of a method of preventing data collisions in the ZigBee network according to an embodiment of the present invention.

Referring to FIG. 7, child nodes receive a beacon from a parent node, and each of the child nodes synchronized with the beacon generates a data packet that is to be transmitted (operation S710).

Next, the child node determines whether to transmit the generated data packet to the parent node or its child node (operation S720).

When it is determined that the data packet is to be transmitted to its child node, the data packet is transmitted by using an indirect transmission scheme such as the conventional CSMA-CA (operation S730).

When it is determined that the data packet is to be transmitted to the parent node, the child node sets a guard time different from those of other child nodes right before transmitting data (operation 5740). In order to set the guard time, one of the methods described with reference to FIGS. 5 and 6 may be used. Here, all child nodes that belong to the same parent node in the network have to use the same method to generate their guard times (that is, all child nodes have to simultaneously use the random delay method, or all the child nodes have to simultaneously use the delay method using the ZigBee parameters).

Each child node performs channel detection and data transmission by using the CSMA-CA after its set guard time (operation S750).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A method of preventing a data collision that occurs when two or more child nodes that belong to a single parent node transmit data to the parent node in a ZigBee network operating in a beacon mode, the method comprising:
performing an operation of the same function to set a different time delay by each of the two or more child nodes synchronized with a beacon received from the parent node; and
detecting whether or not a carrier signal exists in a channel after the set time delay and determining whether or not to transmit data to the parent node.

2. The method of claim 1, wherein the time delay is set based on a random number.

3. The method of claim 2, wherein the time delay is set by a function operation of [basis time×mod(a, b)], where mod(a, b) is a function of returning a remainder after dividing a by b, a is a return function of the random number, and b is the number of slots.

4. The method of claim 3, wherein the number of slots is equal to or larger than the maximum number of child nodes of the parent node.

5. The method of claim 1, wherein the time delay is set based on addresses of the child nodes and an address of the parent node.

6. The method of claim 5, wherein the time delay is set by a function operation of [basis time×{(addresses of child nodes−address of parent node)/Cₛₖᵢₚ(d)}], where Cₛₖᵢₚ(d) is a block portion size of an address that a node having a depth d has.

7. The method of claim 3 or 6, wherein the basis time is equal to or larger than a backoff slot length.
